(19) United States
(12) Patent Application Publication
(10) Pub. No.: US 2015/0115821 A1
(43) Pub. Date: Apr. 30, 2015

(54) LIGHT EMITTING DIODE DRIVER AND METHOD OF CONTROLLING THE SAME

(71) Applicant: SAMSUNG ELECTRO-MECHANICS CO., LTD., Suwon (KR)

(72) Inventors: Je Hyeon YU, Suwon (KR); Deuk Hee PARK, Suwon (KR); Yun Joong LEE, Suwon (KR); Sang Hyun CHA, Suwon (KR); Chang Seok LEE, Suwon (KR); Hye Jin LEE, Suwon (KR)

(73) Assignee: SAMSUNG ELECTRO-MECHANICS CO., LTD., Suwon (KR)

(21) Appl. No.: 14/163,963

(22) Filed: Jan. 24, 2014

(30) Foreign Application Priority Data
Oct. 31, 2013 (KR) 10-2013-0131603

(51) Int. Cl. H05B 33/08

(52) U.S. Cl. CPC H05B 33/0845
USPC 315/200 R

(57) ABSTRACT

There is provided a light emitting diode (LED) driver including: a power supplying unit including a dimmer and a rectifying unit and supplying a supply voltage to an LED device; and a control unit acquiring section information regarding the supply voltage and setting an LED on-time based on the section information.

### CROSS-REFERENCE TO RELATED APPLICATION

This application claims the benefit of Korean Patent Application No. 10-2013-0131603 filed on Oct. 31, 2013, with the Korean Intellectual Property Office, the disclosure of which is incorporated herein by reference.

### BACKGROUND

The present disclosure relates to a light emitting diode driver capable of reducing flicker, and a method of controlling the same.

Alight emitting diode (LED) is a semiconductor device configured as a p-n junction structure which emits light through the recombination of electrons and holes. Such a LED has come into widespread use with the recent evolution of semiconductor technology. Among other advantages, a LED may be beneficial in that it has higher efficiency and longer lifespan than existing light emitting devices and is environmentally-friendly. Therefore, the applications thereof are continually increasing.

In general, since a LED may be driven with a direct-current (DC) voltage of several volts, an additional device is required when a LED is driven with commercially-available domestic alternating-current (AC) power, commonly used in homes and offices. In order to drive an LED with commercially-available domestic AC power, a LED driver typically includes a rectifying circuit, an AC-DC converter or the like.

If an ordinary AC-DC converter is used in a LED driver, however, advantageous features of the LED such as high efficiency, a small package size, and a long lifespan may be compromised due to commonly available AC-DC converters having a large volume and heavy power consumption.

Therefore, research into a device to directly drive an LED with AC power without employing an AC/DC converter is on-going.

In a scheme in which an LED is directly driven with an AC power (herein referred to as “an AC direct driving scheme”), no smoothing capacitor is used so that it is advantageous in terms of the lifespan and size of a LED driving circuit.

In the AC direct driving scheme in which an LED is directly driven with AC power without employing an AC/DC converter, a plurality of switches are connected to a plurality of LEDs and a group of LEDs is switched on or off according to a corresponding level of the AC power. That is, the LED driving circuit in the AC direct driving scheme may be controlled such that groups of LEDs may be automatically switched on or off, according to a change in the voltage of the AC power.

Incidentally, a dimmer may be used to adjust LED brightness. When a dimmer is employed to adjust LED brightness, there may be a difference between waveforms of supply voltages having passed through the dimmer, such that flicker may occur in the LED.

### RELATED ART DOCUMENT

(Patent Document 1) US Patent Application Publication No. 2010/0213870

### SUMMARY

An aspect of the present disclosure may provide an LED driver capable of suppressing the occurrence of flicker in the case that a dimmer is used in an LED driver in an AC direct driving scheme.

According to an aspect of the present disclosure, a light emitting diode (LED) driver may include: a power supplying unit including a dimmer and a rectifying unit and supplying a supply voltage to an LED device; and a control unit acquiring section information regarding the supply voltage and setting an LED on-time based on the section information.

The control unit may acquire off-section information regarding the supply voltage and set the LED on-time based on the off-section information.

The control unit may acquire on-section information regarding the supply voltage and set the LED on-time based on the on-section information.

The control unit may acquire first off-section information and second off-section information, compare the first off-section information with the second off-section information, and set the LED on-time based on the comparison result.

The control unit may set the first off-section information or the second off-section information as the light-emitting delay time.

The control unit may acquire the first off-section information and store off-section comparison information that is shorter than the first off-section information by a predetermined value.

The control unit may compare the off-section comparison information with the second off-section information and set the off-section comparison information or the second off-section information as light-emitting delay time.

The control unit may set the larger of the off-section comparison information and the second off-section information as the light-emitting delay time.

The control unit may store off-section comparison information that is shorter than the light-emitting delay time by a predetermined value.

According to another aspect of the present disclosure, a method of controlling a light emitting diode (LED) driver may include: acquiring section information regarding a supply voltage; setting an LED on-time based on the section information; and driving a LED based on the LED on-time.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram showing a light emitting diode (LED) driver employing a dimmer;

FIG. 2 is a diagram showing an LED driver according to an exemplary embodiment of the present disclosure;

FIG. 3 is a flowchart illustrating a method of controlling an LED driver according to an exemplary embodiment of the present disclosure;

FIGS. 4A and 4B are graphs showing an example of setting an LED on-time;

FIG. 5 shows an example of a method of setting an LED on-time when the supply voltage is changed by a dimmer;

FIG. 6 shows another example of a method of setting an LED on-time; and

FIG. 7 shows another example of a method of setting an LED on-time when the supply voltage is changed by a dimmer.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

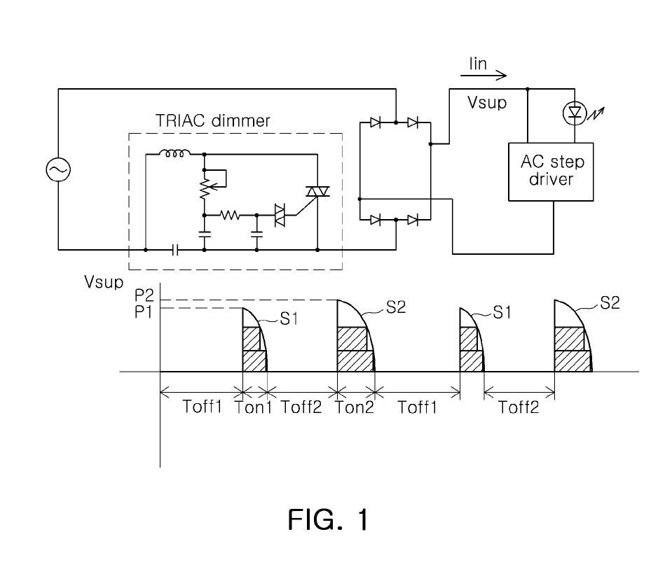

FIG. 1 is a diagram showing a light emitting diode (LED) driver employing a dimmer.

FIG. 1 shows waveforms S1 and S2 of a supply voltage Vₛᵤₚ that has passed through a TRIAC dimmer and a rectifying unit.

In FIG. 1, it is noted that LED on-time corresponds to the shaded portions in the waveforms of the supply voltage Vₛᵤₚ.

As shown in FIG. 1, if an input voltage passes the TRIAC dimmer and the rectifying unit, the first waveform S1 and the second waveform S2 are different in amplitude. The rectifying unit outputs the first waveform S1 and the second waveform S2 alternately.

In this case, there may be a problem that the first LED on-time may be different from the second LED on-time.

If the LED on-times are changed periodically, a flicker may occur in a LED.

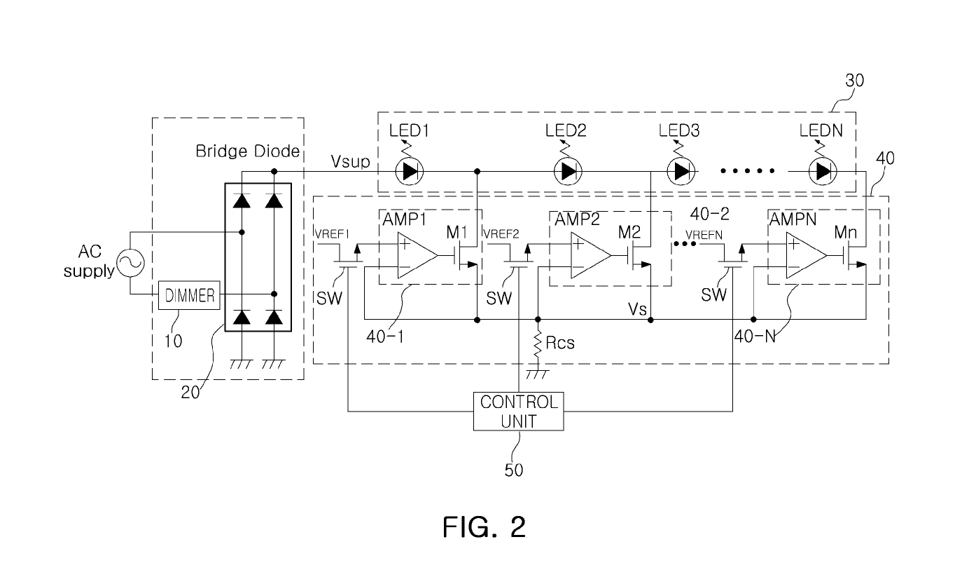

FIG. 2 is a diagram showing an LED driver according to an exemplary embodiment of the present disclosure.

Referring to FIG. 2, the LED driver may include a power supplying unit AC supply, a dimmer 10, a rectifying unit 20, a LED unit 30, a driving unit 40, and a control unit 50.

The power supplying unit AC supply may supply an AC voltage.

The rectifying unit 20 may receive an AC voltage to rectify the full wave or half wave of the input AC voltage, and supplies it to the LED unit 30 so that LEDs may emit light.

The dimmer 10 may adjust the brightness of the LEDs by adjusting waveforms of the voltage from the rectifying unit 20.

The LED unit 30 may include a plurality of LEDs LED 1, LED2, . . . , LED N connected in series. The LEDs may emit light upon being driven by the driving unit 40.

The driving unit 40 may include a plurality of drivers 40-1, 40-2, . . . , 40-N, each of which drives respective LEDs LED 1, LED2, . . . , LED N of the LED unit 30.

The first to Nth drivers 40-1 to 40-N are associated with and drive the first to the Nth LEDs LED 1 to LED N of the LED unit 30, respectively.

Specifically, the first driver 40-1 may be responsible for driving the first LED LED 1. If the voltage level of the voltage rectified by the rectifying unit 20 increases, the first driver 40-1 may stop operating, and then the second driver 40-2 may be responsible for driving the first and second LEDs LED 1 and LED 2, and so on. In this manner, the Nth driver 40-N may be responsible for driving the first to Nth LEDs LED 1 to LED N.

Here, the voltage supplied from the power supplying unit AC supply may be provided to LEDs via the dimmer 10 and the rectifying unit 20. Let us define the voltage supplied to the LEDs from the rectifying unit 20 as the supply voltage Vₛᵤₚ.

The control unit 50 may acquire section information regarding the supply voltage Vₛᵤₚ and may set on-time of LEDs based on the section information.

The section information regarding the supply voltage Vₛᵤₚ relates to the waveform of the supply voltage Vₛᵤₚ. Let us define a section that is cut by the dimmer as off-section information T_{off} and a section that is not cut by the dimmer as on-section information Tₒₙ.

Further, the LED on-time refers to a section in which the LED actually emits light.

The control unit 50 may adjust the on-times of LEDs using switching elements each connected to the respective drivers 40-1 to 40-N.

For instance, the control unit 50 may turn on the switching elements SW after a predetermined time period (e.g., off-section information, light-emitting delay time).

The LEDs may emit light according to the supply voltage Vₛᵤₚ only after the switching elements SW has been turned on.

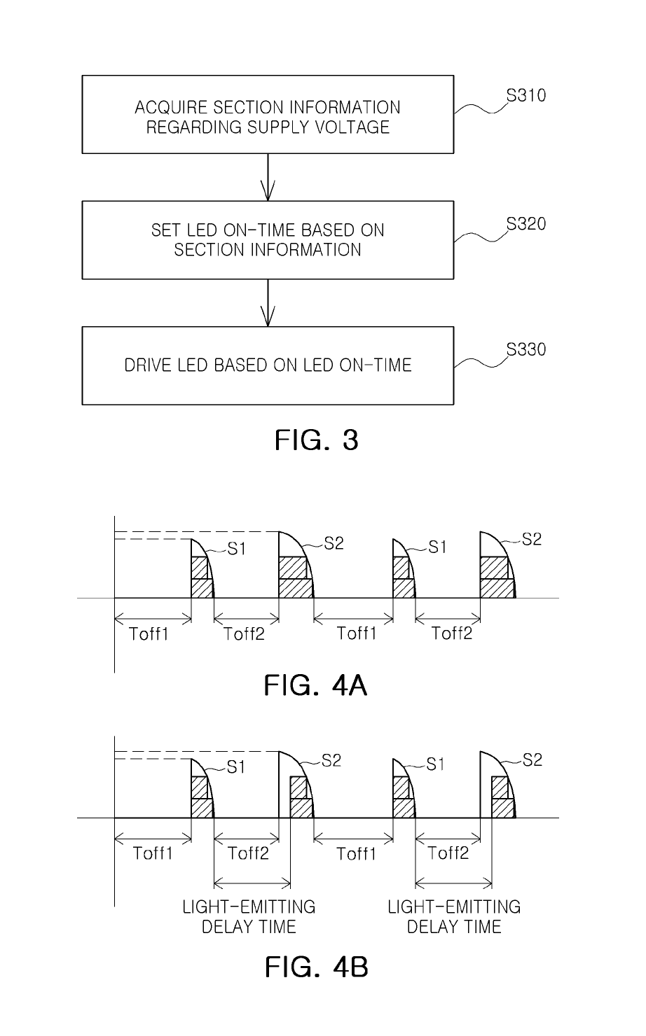

FIG. 3 is a flowchart illustrating a method of controlling an LED driver according to an exemplary embodiment of the present disclosure.

Referring to FIGS. 2 and 3, the control unit 50 may acquire section information regarding the supply voltage (S310). For instance, the control unit 50 may acquire off-section information regarding the supply voltage or on-section information regarding the supply voltage.

According to an exemplary embodiment of the present disclosure, the control unit 50 may set an LED on-time based on the section information (S320).

A method of setting the LED on-time by the control unit 50 will be described in detail with reference to FIGS. 4 through 7.

Then, the control unit 50 may drive LEDs based on the LED on-time (S330).

FIGS. 4A and 4B are graphs showing an example of setting an LED on-time.

FIGS. 4A and 4B are graphs for illustrating an example in which the supply voltage is not changed by the dimmer.

FIG. 4A shows LED on-time without employing the configuration according to an exemplary embodiment of the present disclosure.

As shown in FIG. 4A, since the off-sections T_{off1} and T_{off2} of the supply voltage change periodically, the LED on-time changes periodically.

According to an exemplary embodiment of the present disclosure, the control unit may acquire the first off-section information T_{off1} and the second off-section information T_{off2}. Further, the control unit may compare the first off-section information T_{off1} with the second off-section information T_{off2}. The control unit may set light-emitting delay time based on the comparison result.

The light-emitting delay time may be set by the control unit and refers to the section from after LEDs are turned off until they are turned on.

Specifically, the control unit may set the first off-section information T_{off1} or the second off-section information T_{off2} as the light-emitting delay time.

In the supply voltage output via the dimmer and the rectifying unit, the first waveform S1 and the second waveform S2 are periodically repeated.

Therefore, the first off-section information T_{off1} from after the second waveform S2 is applied until the first waveform S1 is applied, and the second off-section information T_{off2} from after the first waveform S1 is applied until the second waveform S2 is applied are periodically repeated.

As described above, the first off-section information T_{off1} is different from the second off-section information T_{off2}.

Therefore, the first off-section information T_{off1} or the second off-section information T_{off2} needs to be adjusted.

If the first off-section information T_{off1} is greater than the second off-section information T_{off2}, the control unit may store the first off-section information T_{off1} as the light-emitting delay time.

Further, the LEDs may be turned on after the light-emitting delay time instead of the second off-section information T_{off2}.

FIG. 4B shows a waveform of an example in which an LED on-time is delayed until the light-emitting delay time elapses in the period that the LED is to be turned on, following a second off-section T_{off2}.

If the second off-section information T_{off2} is greater than the first off-section information T_{off1}, the control unit may store the second off-section information T_{off2} as the light-emitting delay time.

Further, the LEDs may be turned on after the light-emitting delay time instead of the first off-section T_{off1}.

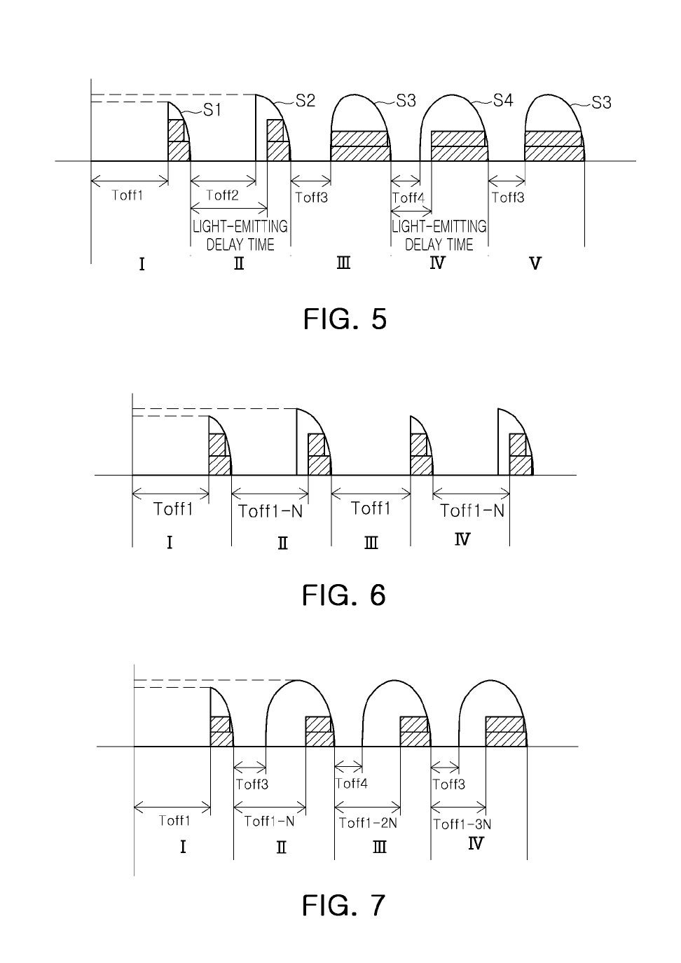

FIG. 5 shows an example of a method of setting an LED on-time when the supply voltage is changed by a dimmer.

In sections I and II, since the first off-section information T_{off1} is greater than the second off-section information T_{off2}, the control unit may store the first off-section information T_{off1} as the light-emitting delay time.

Here, the control unit may store the first off-section information Toff1 as the light-emitting delay time and may apply the light-emitting delay time instead of the second off-section information Toff2.

Accordingly, in section II, the LEDs may be turned on after the light-emitting delay time.

In section III, when the brightness of the LEDs is adjusted by the dimmer, waveforms of the supply voltage also changes.

Since the control unit has stored the first off-section information T_{off1} as the light-emitting delay time and has applied the light-emitting delay time instead of the second off-section information T_{off2} in the previous section, the control unit may store the third off-section information T_{off3} as the light-emitting delay time and apply the light-emitting delay time instead of the fourth off-section information T_{off4} in sections III and IV.

In this manner, the LED driver according to an exemplary embodiment of the present disclosure may suppress a flicker caused by the dimmer.

FIG. 6 shows another example of a method of setting an LED on-time.

In section I, the control unit may acquire the first off-section information T_{off1} and may store off-section comparison information T_{off1-N} that is shorter than the first off-section information T_{off1} by a predetermined value.

In section II, the control unit may compare the off-section comparison information T_{off1-N} with the second off-section information T_{off2} and may set the off-section comparison information T_{off1-N} or the second off-section information T_{off2} as the light-emitting delay time.

For instance, the control unit may set the larger of the off-section comparison information T_{off1-N} and the second off-section information T_{off2} as the light-emitting delay time.

For the convenience of illustration, it is assumed that the off-section comparison information T_{off1-N} is larger than the second off-section information T_{off2}.

In this case, the control unit may set the off-section comparison information T_{off1-N} as the light-emitting delay time.

Accordingly, the LEDs may emit light according to the off-section comparison information T_{off1-N}.

Further, the control unit may store off-section comparison information T_{off1-2N} that is shorter than the light-emitting delay time by a predetermined value.

Similarly, in section III, the control unit may compare the off-section comparison information T_{off1-2N} with the first off-section information T_{off1} and may set the off-section comparison information T_{off1-2N} or the first off-section information T_{off1} as the light-emitting delay time.

For instance, the control unit may set the larger of the off-section comparison information T_{off1-2N} and the first off-section information T_{off1} as the light-emitting delay time.

For the convenience of illustration, it is assumed that the first off-section information T_{off1} is larger than the off-section comparison information Toff_{1-2N}.

In this case, the control unit may set the first off-section information T_{off1} as the light-emitting delay time.

Accordingly, the LEDs may emit light according to the first off-section information T_{off1}.

Further, the control unit may store the off-section comparison information T_{off1-N} that is shorter than the light-emitting delay time by a predetermined value.

Similarly, in section IV, the control unit may compare the off-section comparison information T_{off1-N} with the second off-section information T_{off2} and may set the off-section comparison information T_{off1-N} or the second off-section information T_{off2} as the light-emitting delay time.

For instance, the control unit may set the larger of the off-section comparison information T_{off1-N} and the second off-section information T_{off2} as the light-emitting delay time.

In this case, the control unit may set the off-section comparison information T_{off1-N} as the light-emitting delay time.

Accordingly, the LEDs may emit light according to the off-section comparison information T_{off1-N}.

Further, the control unit may store the off-section comparison information T_{off1-2N} that is shorter than the light-emitting delay time by a predetermined value.

Because the first off-section information T_{off1} and the off-section comparison information T_{off1-N} have the same size, a flicker in the LEDs may be significantly reduced.

FIG. 7 shows another example of a method of setting an LED on-time when the supply voltage is changed by a dimmer.

In section I, the control unit may acquire the first off-section information T_{off1} and may store off-section comparison information T_{offifiN} that is shorter than the first off-section information T_{off1} by a predetermined value.

In this example, it is assumed that the waveform of supply voltage is significantly changed by the dimmer in section II.

In this case, after section II, the first off-section information T_{off1} and the second off-section information T_{off2} are changed to the third off-section information T_{off3} and the fourth off-section information T_{off4}.

In section II, the control unit may compare the off-section comparison information T_{off1-N} with the third off-section information T_{off3} and may set the off-section comparison information T_{off1-N} or the third off-section information T_{off3} as the light-emitting delay time.

For instance, the control unit may set the larger of the off-section comparison information T_{off1-N} and the third off-section information T_{off3} as the light-emitting delay time.

For the convenience of illustration, it is assumed that the off-section comparison information T_{off1-N} is larger than the third off-section information T_{off3}.

In this case, the control unit may set the off-section comparison information T_{off1-N} as the light-emitting delay time.

Accordingly, the LEDs may emit light according to the off-section comparison information T_{off1-N}.

Further, the control unit may store off-section comparison information T_{off1-2N} that is shorter than the light-emitting delay time by a predetermined value.

Similarly, in section III, the control unit may compare the off-section comparison information T_{off1-2N} with the fourth off-section information T_{off4} and may set the off-section comparison information T_{off1-2N} or the fourth off-section information T_{off4} as the light-emitting delay time.

For instance, the control unit may set the larger of the off-section comparison information T_{off1-2N} and the fourth off-section information T_{off4} as the light-emitting delay time.

For the convenience of illustration, it is assumed that the off-section comparison information T_{off1-2N} is larger than the fourth off-section information T_{off4}.

In this case, the control unit may set the off-section comparison information T_{off1-2N} as the light-emitting delay time.

Accordingly, the LEDs may emit light according to the off-section comparison information T_{off1-2N}.

Further, the control unit may store off-section comparison information T_{off1-3N} that is shorter than the light-emitting delay time by a predetermined value.

Similarly, in section IV, the control unit may compare the off-section comparison information T_{off1-3N} with the third off-section information T_{off3} and may set the off-section comparison information T_{off1-3N} or the third off-section information T_{off3} as the light-emitting delay time.

For instance, the control unit may set the larger of the off-section comparison information T_{off1-3N} and the third off-section information T_{off3} as the light-emitting delay time.

For the convenience of illustration, it is assumed that the off-section comparison information T_{off1-3N} is larger than the third off-section information T_{off3}.

In this case, the control unit may set the off-section comparison information T_{off1-3N} as the light-emitting delay time.

Accordingly, the LEDs may emit light according to the off-section comparison information T_{off1-3N}.

Further, the control unit may store off-section comparison information T_{off1-4N} that is shorter than the light-emitting delay time by a predetermined value.

According to the methods described above, the control unit may apply the light-emitting delay time in response to the change in the brightness of the dimmer.

The larger the value N by which the light-emitting delay time is reduced is, the more quickly the control unit may respond to the change in the brightness of the dimmer. However, since a flicker is more likely to occur as the value N by which the light-emitting delay time is reduced becomes larger, the value N by which the light-emitting delay time is reduced may be appropriately adjusted.

In this manner, a flicker possibly occurring when a dimmer is employed in an LED driver of an AC direct driving scheme may be suppressed.

Although the scheme in which the control unit sets LED on-time based on the off-section information has been described in the specification, it is apparent to those skilled in the art that the LED on-time may be set based on on-section information.

As set forth above, according to exemplary embodiments of the present disclosure, an LED driver capable of suppressing a flicker possibly occurring when a dimmer is employed in the LED driver of an AC direct driving scheme may be provided.

While exemplary embodiments have been shown and described above, it will be apparent to those skilled in the art that modifications and variations could be made without departing from the spirit and scope of the present disclosure as defined by the appended claims.

What is claimed is:

1. A light emitting diode (LED) driver, comprising:
a power supplying unit including a dimmer and a rectifying unit and supplying a supply voltage to an LED device; and
a control unit acquiring section information regarding the supply voltage and setting an LED on-time based on the section information.

2. The LED driver of claim 1, wherein the control unit acquires off-section information regarding the supply voltage and sets the LED on-time based on the off-section information.

3. The LED driver of claim 1, wherein the control unit acquires on-section information regarding the supply voltage and sets the LED on-time based on the on-section information.

4. The LED driver of claim 2, wherein the control unit acquires first off-section information and second off-section information, compares the first off-section information with the second off-section information, and sets the LED on-time based on the comparison result.

5. The LED driver of claim 4, wherein the control unit sets the first off-section information or the second off-section information as light-emitting delay time.

6. The LED driver of claim 1, wherein the control unit acquires the first off-section information and stores off-section comparison information that is shorter than the first off-section information by a predetermined value.

7. The LED driver of claim 6, wherein the control unit compares the off-section comparison information with the second off-section information and sets the off-section comparison information or the second off-section information as light-emitting delay time.

8. The LED driver of claim 7, wherein the control unit sets a larger of the off-section comparison information and the second off-section information as light-emitting delay time.

9. The LED driver of claim 8, wherein the control unit stores off-section comparison information that is shorter than the light-emitting delay time by a predetermined value.

10. A method of controlling a light emitting diode (LED) driver, comprising:
acquiring section information regarding a supply voltage;
setting an LED on-time based on the section information; and
driving a LED based on the LED on-time.
